(19) United States
(12) Patent Application Publication
(10) Pub. No.: US 2005/0128888 A1
(43) Pub. Date: Jun. 16, 2005

(54) Magneto-optical recording medium and magneto-optical storage device

(75) Inventors: Tetsuo Hosokawa, Kawasaki (JP); Nobuhide Aoyama, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/043,703

(22) Filed: Jan. 26, 2005

(30) Foreign Application Priority Data
Dec. 13, 2002 (WO) PCT/JP02/13085

(51) Int. Cl. G11B 7/24

(52) U.S. Cl. 369/13.54; 369/13.35; 369/275.4

(57) ABSTRACT

A magneto-optical recording medium has a substrate having a ROM area with a plurality of phase pits defined therein as providing a ROM signal, and a magneto-optical recording film deposited in an area of said substrate which corresponds to said ROM area, for recording a RAM signal. The phase pits have edges having an average angle of inclination ranging from 10° to 40° at a position in a range of one-half of the depth of each of the phase pits ±20%. Each of said phase pits has a width ranging from 300 nm to 500 nm, and is modulated by a modulation factor ranging from 10% to 30%.

This is a continuation of PCT International Application NO. PCT/JP02/13085, filed Dec. 13, 2002, which was not published in English.

### BACKGROUND OF THE INVENTION

1. Field of the Invention

The present invention relates generally to a magneto-optical recording medium, and more particularly to a magneto-optical recording medium capable of simultaneously reproducing ROM/RAM information.

2. Description of the Related Art

FIG. 1 of the accompanying drawings is a plan view of an example of a conventional magneto-optical disk according the ISO standards. The magneto-optical disk has a lead-in area 2 and a lead-out area 4. The lead-in and -out areas 2 and 4 store ROM information representative of usage of the disk, etc. in the form of phase pits that are formed by lands and grooves on a. polycarbonate substrate. The depth of the phase pits representing the ROM information is set to maximize the optical intensity modulation upon reproduction of the information. The magneto-optical disk also has a user area 6 disposed between the lead-in area 2 and the lead-out area 4 and having a magneto-optical recording film deposited by a sputtering apparatus. The user area 6 stores information that can freely be recorded by the user.

FIG. 2 of the accompanying drawings is a partial plan view showing the user area 6 on an enlarged scale. Lands 10 sandwiched between grooves 8 serving as tracking guides have a header area 12 including phase pits 16 and a user data area 14. The header area 12 contains information representing sector marks, VFO, and ID according to a sector format. The user data area 14, which is provided by flat regions of the lands 10 sandwiched between the grooves 8, contains a recorded magneto-optical signal.

FIG. 3 of the accompanying drawings is a cross-sectional view taken along line III-III of FIG. 2. The magneto-optical disk has a laminated structure including a substrate 18 made of polycarbonate or the like, a dielectric film 20, a magneto-optical recording film 22 made of TbFeCo or the like, a dielectric film 24, an Al film 26, and ultraviolet-cured film 28 serving as a protective layer. In FIG. 3, the grooves 8 are shown as being modified from the shape shown in FIG. 2 so as to have the same radial width as the lands 10 in order for the grooves 8 to perform magneto-optical recording.

For reading a magneto-optical signal from the magneto-optical disk, a low-intensity laser beam is applied to the magneto-optical disk. At this time, the plane of polarization of the laser beam is changed by the polar Kerr effect depending on the magnetized direction of the recording layer, and it is determined whether or not there is a signal based on the intensity of the polarized component of the laser beam reflected from the magneto-optical disk. In this manner, the recorded RAM information can be read from the magneto-optical disk.

Research and development efforts have been made to utilize the features of such an optical disk memory. For example, Japanese Laid-open No. Hei 6-202820 discloses a concurrent ROM-RAM optical disk capable of simultaneously reproducing ROM (Read Only Memory) information and RAM (Random Access Memory) information. A magneto-optical recording medium, which is capable of simultaneously reproducing ROM information and RAM information, has a radial cross-sectional structure as shown in FIG. 4 of the accompanying drawings. The magneto-optical recording medium has a laminated structure including a substrate 18 made of polycarbonate or the like, a dielectric film 20, a magneto-optical recording film 22 made of TbFeCo or the like, a dielectric film 24, an Al film 26, and ultraviolet-cured film 28 serving as a protective layer.

As shown in FIG. 5 of the accompanying drawings, on the magneto-optical recording medium of the above structure, ROM information is fixedly recorded as phase pits PP and RAM information is recorded as magneto-optical recording spots OMM on the trains of the phase pits PP. A cross-sectional view taken along line IV-IV of FIG. 5 corresponds to FIG. 4. In the example shown in FIG. 5, however, the grooves 8 shown in FIG. 2 are not provided because the phase pits PP serves as tracking guides.

There are many problems encountered in simultaneously reproducing ROM information recorded in the form of phase pits PP and RAM information recorded in the form of magneto-optical recording spots OMM from an optical recording medium, which has the ROM information and the RAM information on one recording surface. First, the optical intensity modulation caused in reading the ROM information is responsible for noise produced in reproducing the RAM information when the ROM information and the RAM information are to be stably reproduced. An attempt has heretofore been made to reduce the optical intensity modulation noise by controlling a readout drive laser with a negative feedback control loop using an optical intensity modulation signal that is generated when the ROM information is read. However, the attempt is not effective enough to reduce the noise if the optical intensity modulation of the ROM information is large. It is also difficult to control the laser beam intensity at a high speed with the feedback control loop.

### SUMMARY OF THE INVENTION

It is an object of the present invention to provide a magneto-optical recording medium capable of stably reproducing both ROM information and RAM information when the ROM information and the RAM information are to be simultaneously read.

Another object of the present invention is to provide a magneto-optical recording medium capable of improving ROM signal jitter and magneto-optical (MO) signal jitter in a ROM area when ROM information and RAM information are to be simultaneously read.

Still another object of the present invention is to provide a magneto-optical storage device capable of improving ROM signal jitter and magneto-optical (MO) signal jitter in a ROM area when ROM information and RAM information are to be simultaneously read.

In accordance with an aspect of the present invention, there is provided a magneto-optical recording medium including a substrate having a ROM area with a plurality of phase pits defined therein as providing a ROM signal, and a magneto-optical recording film deposited in an area of the substrate which corresponds to the ROM area, for recording a RAM signal, the phase pits having edges having an average angle of inclination ranging from 10° to 40° at a position in a range of one-half of the depth of each of the phase pits ±20%.

Preferably, each of the phase pits has a width ranging from 300 nm to 500 nm, and is modulated by a modulation factor ranging from 10% to 30%. The magneto-optical recording medium further includes a dielectric layer disposed between the substrate and the magneto-optical recording film. The dielectric layer has a film thickness which is at least 10% of the wavelength of a reproducing laser beam to be applied to the magneto-optical recording medium, and the magneto-optical recording medium has a reflectance ranging from 18% to 25% with respect to a reproducing laser beam in a region free of the phase pits. Preferably, each of the phase pits has a width ranging from 30% to 50% of the diameter of a reproducing laser beam.

In accordance with another aspect of the present invention, there is provided a magneto-optical storage device for at least reading information recorded in a magneto-optical recording medium, including an optical head for applying a linearly polarized laser beam to the magneto-optical recording medium, and a photodetector for generating a reproduced signal from a light beam reflected from the magneto-optical recording medium, the magneto-optical recording medium including a substrate having a ROM area with a plurality of phase pits defined therein as providing a ROM signal, and a magneto-optical recording film deposited in an area of the substrate which corresponds to the ROM area, for recording a RAM signal, the phase pits having edges having an average angle of inclination ranging from 10° to 40° at a position in a range of one-half of the depth of each of the phase pits ±20%.

Preferably, the laser beam applied to the magneto-optical recording medium has a plane of polarization set to a range of a direction perpendicular to the longitudinal direction of the phase pits ±5°.

In accordance with further aspect of the present invention, there is provided a stamper for producing a substrate having a plurality of phase pits, including a plurality of lands complementary in shape to the phase pits, respectively, the lands having edges having an average angle of inclination ranging from 10° to 40° at a position in a range of one-half of the height of each of the lands ±20%. Preferably, the average angle of inclination ranges from 15° to 30°.

The above and other objects, features, and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a plan view of a conventional magneto-optical disk according to ISO standards;

FIG. 2 is a partial plan view showing a user area on an enlarged scale;

FIG. 3 is a cross-sectional view taken along line III-III of FIG. 2;

FIG. 4 is a radial cross-sectional view of a magneto-optical recording medium capable of simultaneously reproducing ROM information and RAM information;

FIG. 5 is a plan view of the magneto-optical recording medium;

FIG. 6 is a view showing a layout of phase pits serving as a premise for understanding the features of a magneto-optical recording medium according to the present invention;

FIG. 7 is a view illustrative of an angle of inclination of an edge of a phase pit formed in a substrate;

FIG. 8 is a view showing a stamper;

FIG. 9 is a view showing the manner in which lands on the stamper are pressed against a substrate to form phase pits therein;

FIG. 10 is a cross-sectional view of a magneto-optical recording medium according to an embodiment of the present invention;

FIG. 11 is a graph showing MO signal jitter in a ROM area and reproduced ROM signal jitter with respect to different angles of phase pit edges;

FIG. 12 is a graph showing the relationship between the depth of phase pits and the modulation of a reproduced phase pit signal when the angle of inclination of the phase pit edge is about 20°;

FIG. 13 is a graph showing ROM signal jitter and MO signal jitter in a ROM area at different modulations;

FIG. 14 is a graph showing measured data of ROM signal jitter and MO signal jitter in a ROM area at different phase pit widths;

FIG. 15 is a diagram showing the direction of polarization of an incident light beam with respect to the shape of a phase pit;

FIG. 16 is a graph showing how the reflectance changes depending on the film thickness of an undercoat SiN layer at the time an N₂ gas flows at a rate of 33 sccm;

FIG. 17 is a graph showing reproduced MO signal jitter in a ROM area and ROM signal jitter at different undercoat SiN layer film thicknesses;

FIG. 18 is a graph showing how the film thicknesses of undercoat SiN layers change with deposition time;

FIG. 19 is a graph showing how the reflectance changes with deposition time at different N₂ gas flow rates as a parameter;

FIG. 20 is a graph showing ROM signal jitter and MO signal jitter in a ROM area at different deposition times;

FIG. 21 is a block diagram of a magneto-optical disk device according to an embodiment of the present invention;

FIG. 22 is a detailed block diagram of a main controller of the magneto-optical disk device;

FIG. 23 is a diagram showing detected combinations of ROM1, ROM2, and RAM in various modes; and

FIG. 24 is a block diagram of an encryption unit and a decryption unit, the diagram also showing a processing sequence thereof.

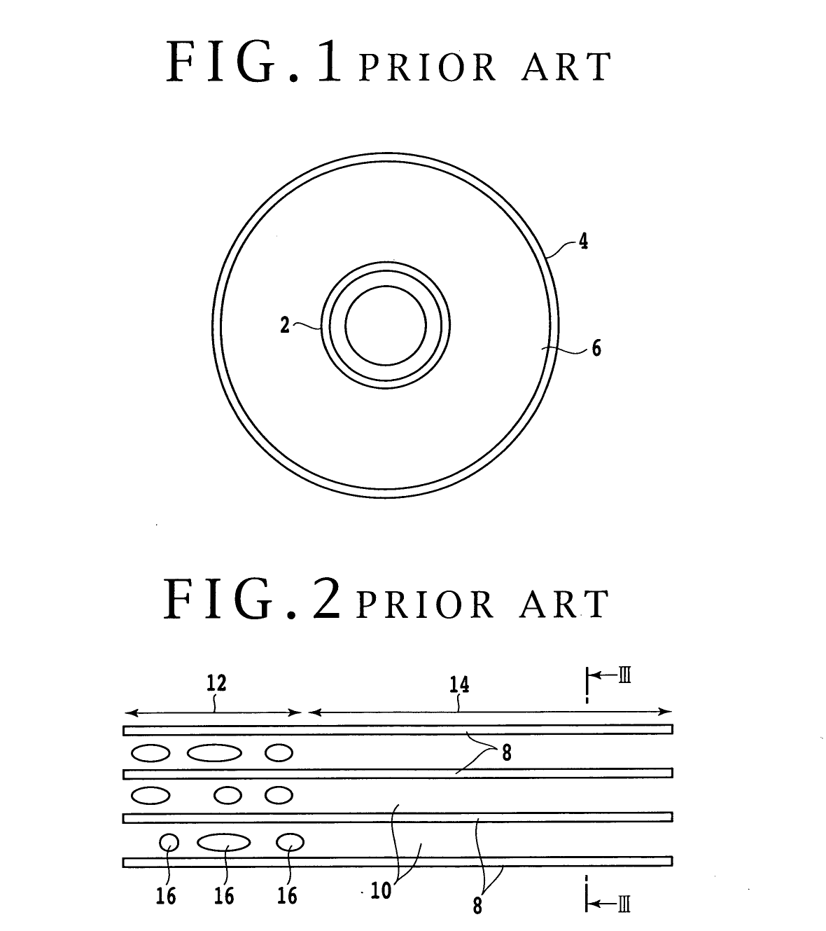

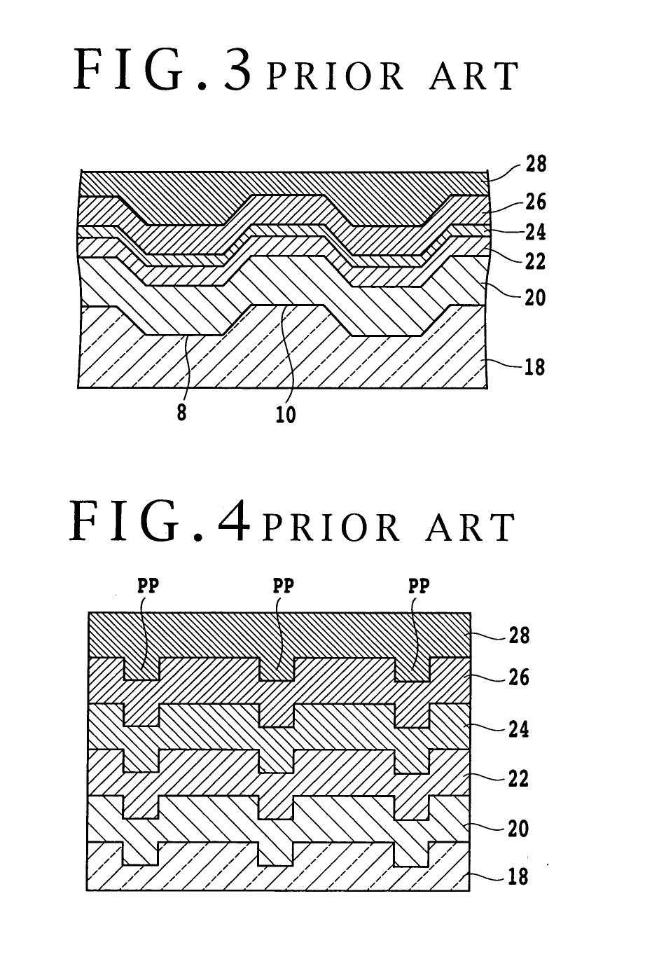

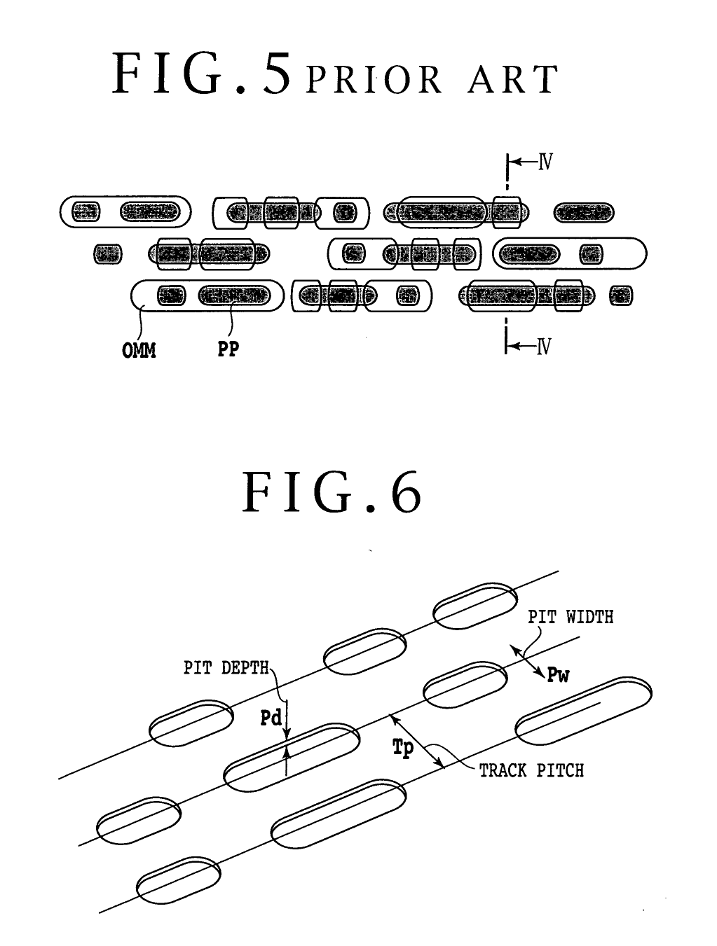

### DETAILED DESCRIPTION OF THE PREFERRED EMBODIMENTS

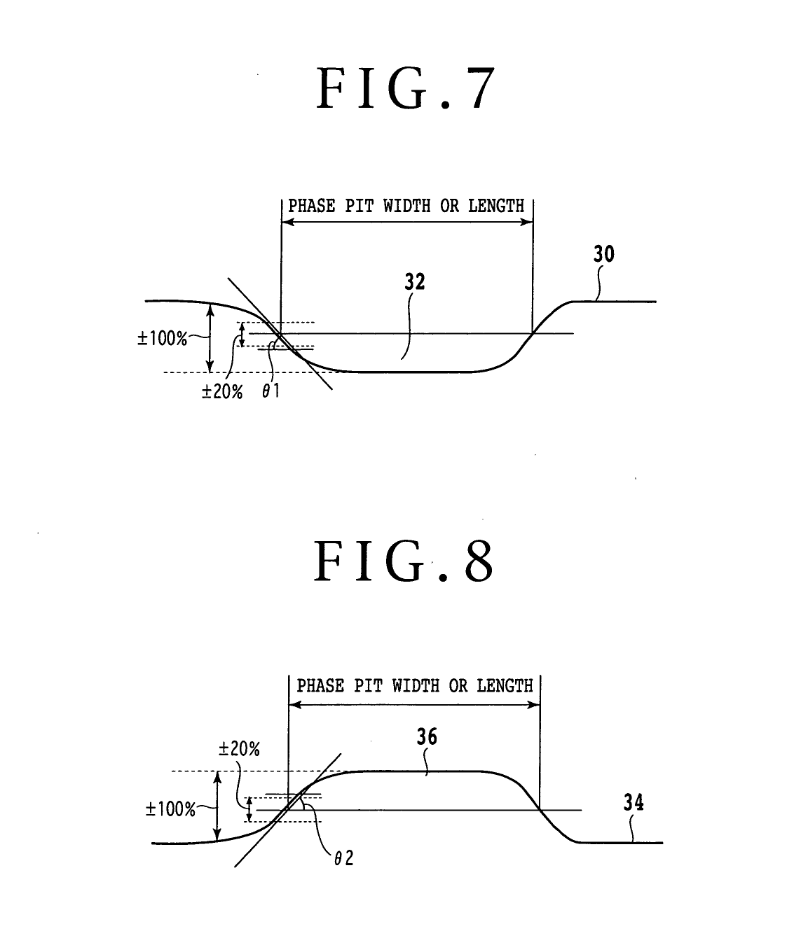

FIG. 6 shows a layout of phase pits, which serve as a premise for understanding the features of a magneto-optical recording medium according to the present invention. In FIG. 6, each of the phase pits has a depth Pd, i.e., an optical depth. A track pitch Tp represents the radial distance between phase pits, and a pit width Pw represents the radial width of each phase pit. In an experiment described below, a polycarbonate substrate having a track pitch Tp of 1.6 μm, a pit width Pw of 0.40 μm, a minimum pit length of 0.8 μm, and a pit depth Pd of 40 nm was prepared. At this time, a plurality of substrates having differently adjusted angles θ1 of edges of pits 32 (see FIG. 7), each formed to a depth of about 40 nm in a substrate 30, were prepared by controlling the film thicknesses of photoresists applied to stampers in a stamper production process and applying ultraviolet rays to the substrates.

Specifically, the phase pits 32 had several random lengths at certain intervals, the minimum length being of 0.8 μm. The angle θ1 of the pit edge was adjustable by the application of ultraviolet rays to the substrate 30. Though the pits 32 were reduced in depth by the application of ultraviolet rays, the reduction of the depth was compensated for by the film thickness of the photoresist in the stamper production process. In this manner, a plurality of substrates having substantially the same pit depth and different angles θ1 of pit edges were prepared. The angle θ1 of the pit edge can be adjusted by the application of ultraviolet rays in a photoresist process at the time a stamper is produced. Alternatively, the angle θ1 of the pit edge may be adjusted by a process such as a plasma process. FIG. 8 shows a stamper 34 having a land 36 disposed at a position corresponding to a phase pit 32 in the substrate 30 and having a shape complementary to the phase pit 32. The land 36 has an edge inclined at an angle θ2.

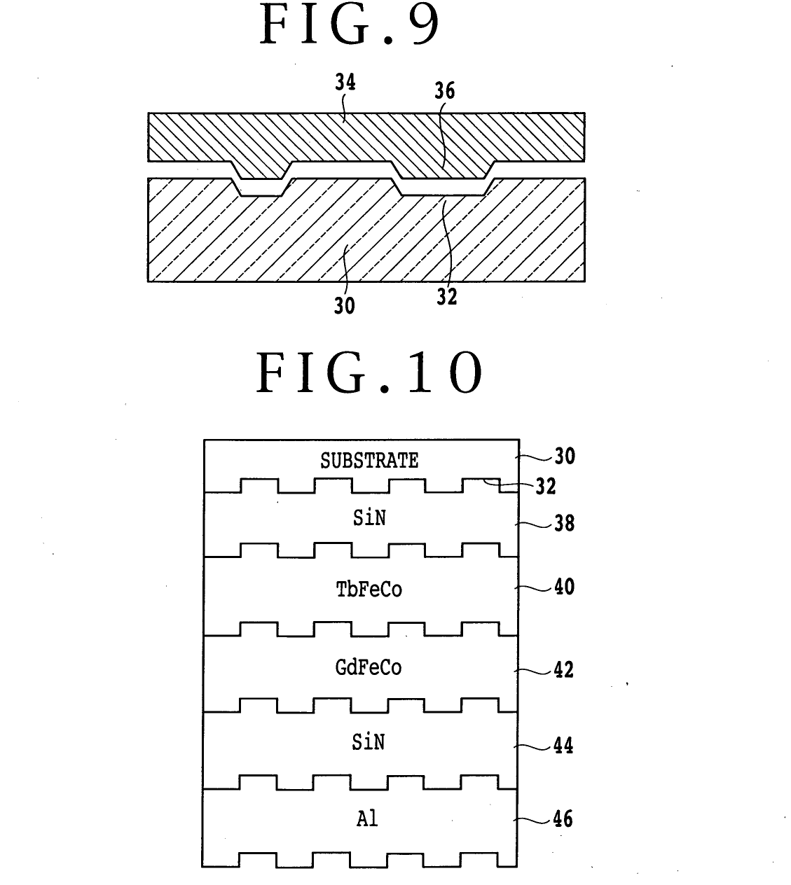

FIG. 9 shows the manner in which lands 36 on the stamper 34 are pressed against the substrate 30 to form phase pits 32 therein. In this case, the angle θ1 is substantially the same as the angle θ2. The stamper 34 is made of a nickel alloy. The stamper 34 is set in a die assembly, and pressed against a blank by a press, forming the substrate 30 with the phase pits 32. When the stamper 34 is pressed against the blank, the lands 36 form complementarily shaped phase pits 32 in the substrate 30. The substrate 30 is made of polycarbonate or the like.

The substrate 30 was placed in a sputtering apparatus having a plurality of film deposition chambers that are evacuated to a vacuum level of 5×10⁻⁵ Pascal (Pa) or lower. First, the substrate 30 was put in a first chamber in which an Si target was mounted. An Ar gas and an N₂ gas were introduced into the first chamber, and DC electric power of 3 kW was applied to deposit an undercoat SiN layer (dielectric layer) 38 on the substrate 30 according to reactive sputtering. The deposition time and the flow rate of the N₂ gas were changed to produce a plurality of samples having different thicknesses and reflectances of undercoat SiN layers 38. The Ar gas was introduced at a flow rate of 50 sccm (1 sccm=1.677×10⁻⁸ m³/s). Then, each substrate 30 was placed in another chamber in which a recording layer 40 of a rare earth transition metal such as Tb₂₂(FeCo₁₂)₇₈ or the like was deposited on the undercoat SiN layer 38. Then, the substrate 30 was placed in still another chamber in which a recording assistive layer 42 of Gd₁₉(FeCo₂₀)₈₁ was deposited to a thickness of 7 nm on the recording layer 40. Then, the substrate 30 was placed in the first chamber in which an overcoat SiN layer 44 was deposited to a thickness of 15 nm on the recording assistive layer 42. Furthermore, the substrate 30 was placed in another chamber in which a reflecting layer 46 of Al deposited to a thickness of 50 nm on the overcoat SiN layer 44. An ultraviolet-cured coating layer of synthetic resin was deposited on the reflecting layer 46, thereby completing a magneto-optical recording medium shown in FIG. 10.

Each of the samples thus prepared was installed in a recording/reproducing apparatus having a light beam wavelength of 650 nm, a numerical aperture NA of 0.55, and a light beam diameter of 1.08 μm (1/e²), and was rotated at a linear velocity of 4.8 m/s. An optically modulated signal was recorded in the form of marks whose minimum length was 0.8 μm in a ROM area of each sample according to the 1-7 modulation process, and ROM signal jitter due to the phase pits and MO signal jitter in the ROM area were measured. The term “jitter” used herein refers to variations of the lengths of the marks. The ROM area contains phase pits having a minimum mark length of 0.8 μm. A laser beam was focused onto a mirror surface of each sample that was free of the phase pits to measure the reflectances of the samples having the different undercoat SiN layers 38. Specifically, a laser beam having a plane of polarization perpendicular to the longitudinal direction of the phase pits was applied to each sample installed in the recording/reproducing apparatus.

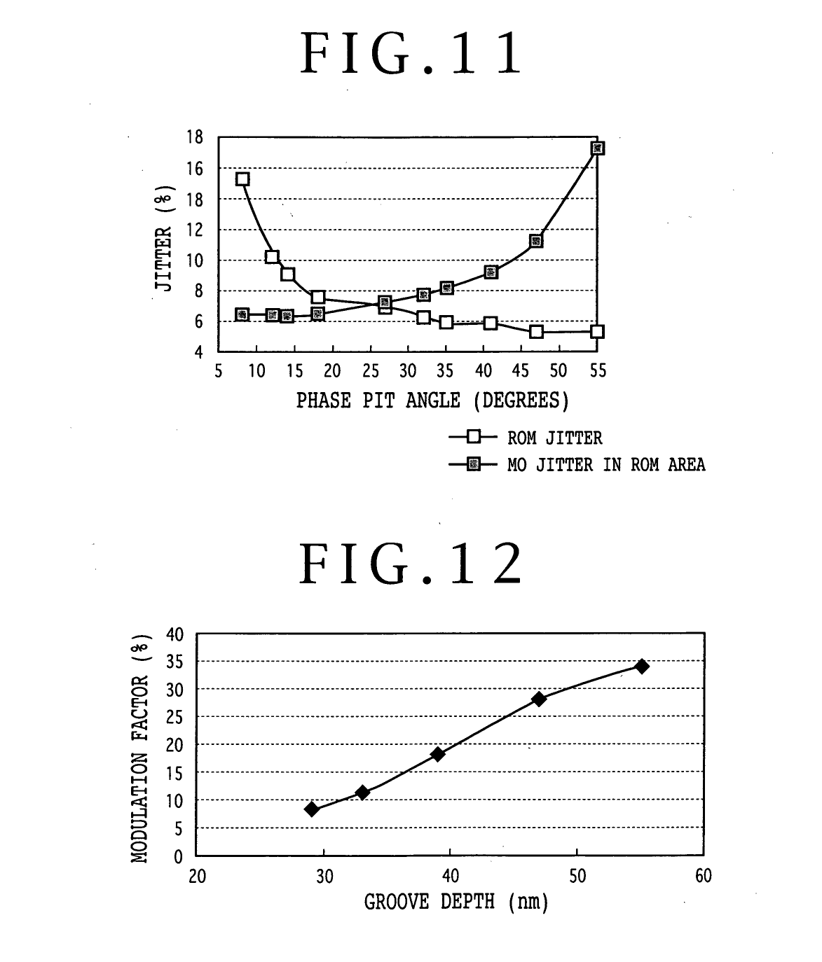

FIG. 11 shows MO signal jitter in the ROM area and reproduced ROM signal jitter with respect to different angles of phase pit edges. The undercoat SiN layer 38 was deposited to a thickness of 80 nm, and the N₂ gas was introduced at a flow rate of 33 sccm. The angles of phase pit edges, represented by θ1 shown in FIG. 7, were measured by an atomic force microscope (AFM) at a position corresponding to one-half of the depth of the phase bit 32±20%. The reflectance of the mirror surface of this sample was 23%. As can be seen from FIG. 11, when the angle of inclination of the phase bit edge becomes larger, the MO signal jitter in the ROM area increases. When the angle of inclination of the phase bit edge becomes 40° or greater, the MO signal jitter in the ROM area increases sharply. Conversely, when the angle of inclination of the phase bit edge becomes smaller, the ROM signal jitter increases. When the angle of inclination of the phase bit edge becomes 10° or smaller, the ROM signal jitter increases sharply.

It is understood, therefore, that in order to make both the MO signal jitter in the ROM area and the ROM signal jitter equal to or smaller than a favorable level of 10%, the angle of inclination of the phase bit edge should be set in a range from 10° to 40°, and more preferably in a range from 15° to 35°, which achieves the jitter of equal to or smaller than 8%. It is not known why the MO signal jitter in the ROM area becomes lower when the angle of inclination of the phase bit edge is smaller. It is inferred, however, that the MO signal jitter in the ROM area may probably be improved because any disturbances of the magnetized direction of the MO film are reduced, thereby reducing disturbances of the plane of polarization upon signal reproduction.

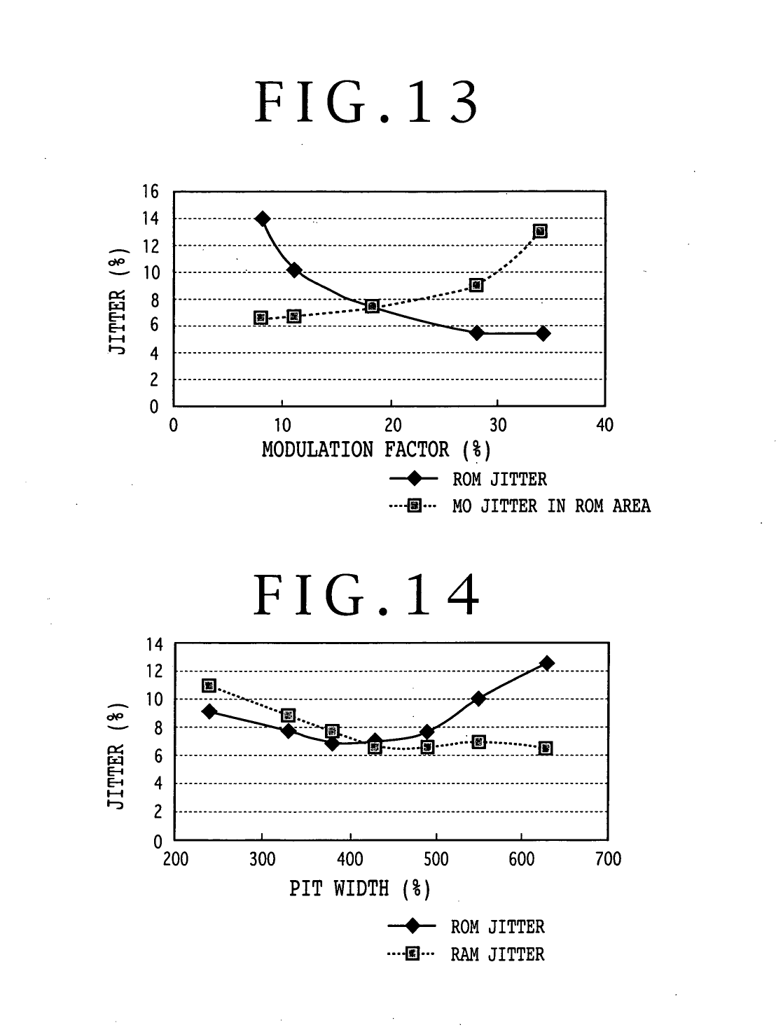

FIG. 12 shows the relationship between the depth of phase pits and the modulation of a reproduced phase pit signal when the angle of inclination of the phase pit edge is about 20°. The modulation was defined as 100× phase pit signal amplitude/reflection level (%). The reflection level refers to the level of a reflection from a flat area free of phase pits. For example, the flat area is an area free of phase pits of the magneto-optical recording medium shown in FIG. 6. As the phase pit becomes deeper, the modulation increases. For adjusting the depth of phase pits in the substrate, the height of corresponding lands on the stamper is slightly adjusted substantially into agreement with the depth of the phase pits. FIG. 13 shows ROM signal jitter and MO signal jitter in the ROM area at different modulations. A review of FIG. 13 clearly shows that both the ROM signal jitter and the MO signal jitter in the ROM area are favorable when the modulation ranges from 10% to 30%.

FIG. 14 shows measured data of ROM signal jitter and MO signal jitter in the ROM area at different phase pit widths when the angle of inclination of the phase bit edge was 20° and the phase pits had a depth of 40 nm. As can be seen from FIG. 14, the ROM signal jitter increases when the pit width is 500 nm or higher, and the MO signal jitter suffers a significant increase when the pit width is 300 nm or lower. Therefore, the width of the phase pits should preferably in the range from 300 nm to 500 nm.

Table 1 shown below indicates MO signal jitter in the ROM area at different directions of polarization of the incident light beam when the angle of inclination of the phase bit edge is 20°, the phase pits has a depth of 40 nm, and the phase pit width is 390 nm.

TABLE 1

| | Direction of polarization of | | | | | | |
|---|---|---|---|---|---|---|---|
| | incident light beam | | | | | | |
| | 0 | 80 | 85 | 90 | 95 | 100 | (°) |
| MO signal jitter in | 10.8 | 13.5 | 7.8 | 6.3 | 8.0 | 14.3 | (%) |
| ROM area | | | | | | | |

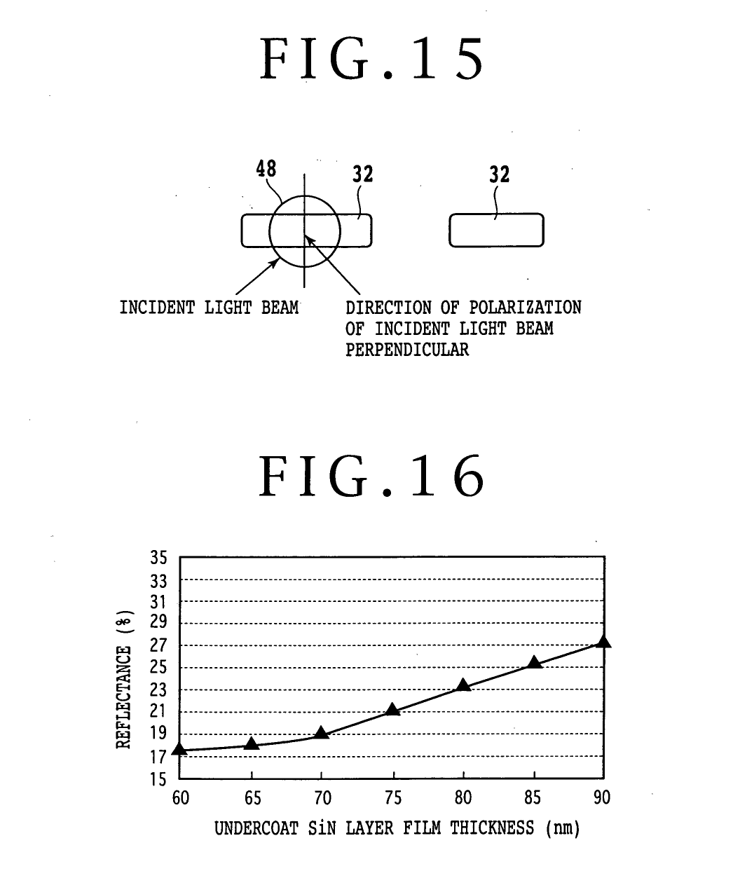

It can be understood from Table 1 that the MO signal jitter in the ROM area is better in the vertical direction of polarization than in the horizontal direction of polarization, and can be set to a favorable level if the direction of polarization is in a range of the vertical direction ±5°. The direction of polarization refers to the angle of polarization of an incident light beam 48 (see FIG. 15) with respect to the longitudinal direction of the phase pits 32.

Table 2 show below indicates ROM signal jitter of the phase pits of the same sample as used to provide the data shown in Table 1, both when an MO signal was produced and no MO signal was produced.

TABLE 2

| | Direction of polarization | | | | | | |
|---|---|---|---|---|---|---|---|
| | of incident light beam | | | | | | |
| | 0 | 80 | 85 | 90 | 95 | 100 | (°) |
| ROM signal jitter, with | 5.3 | 5.5 | 5.9 | 5.5 | 5.3 | 5.5 | (%) |
| no MO signal | | | | | | | |
| ROM signal jitter, with | 10.9 | 10.3 | 6.3 | 5.6 | 5.7 | 6.8 | (%) |
| MO signal | | | | | | | |

Since the ROM signal is produced by detecting a signal indicative of intensity changes of a reproduced laser beam, the MO signal does not leak, in principle, into the ROM signal due to changes in the direction of polarization. It is seen from Table 2 that with MO marks erased, substantially constant and acceptable ROM signal jitter is obtained regardless of the direction of polarization of the reproduced laser beam. However, when MO marks are recorded in the ROM area, the MO signal leaks into the reproduced ROM signal, resulting in increased jitter. Particularly, jitter is significantly increased when the reproduced laser beam has a horizontal plane of polarization. Any increase in the jitter due to the MO signal is small when the reproduced laser beam has a vertical plane of polarization. The above results indicate that both the leakage of the ROM signal into the MO signal and the leakage of the MO signal into the ROM signal can be reduced by making the plane of polarization of the reproduced laser beam perpendicular to the longitudinal direction of the phase pits.

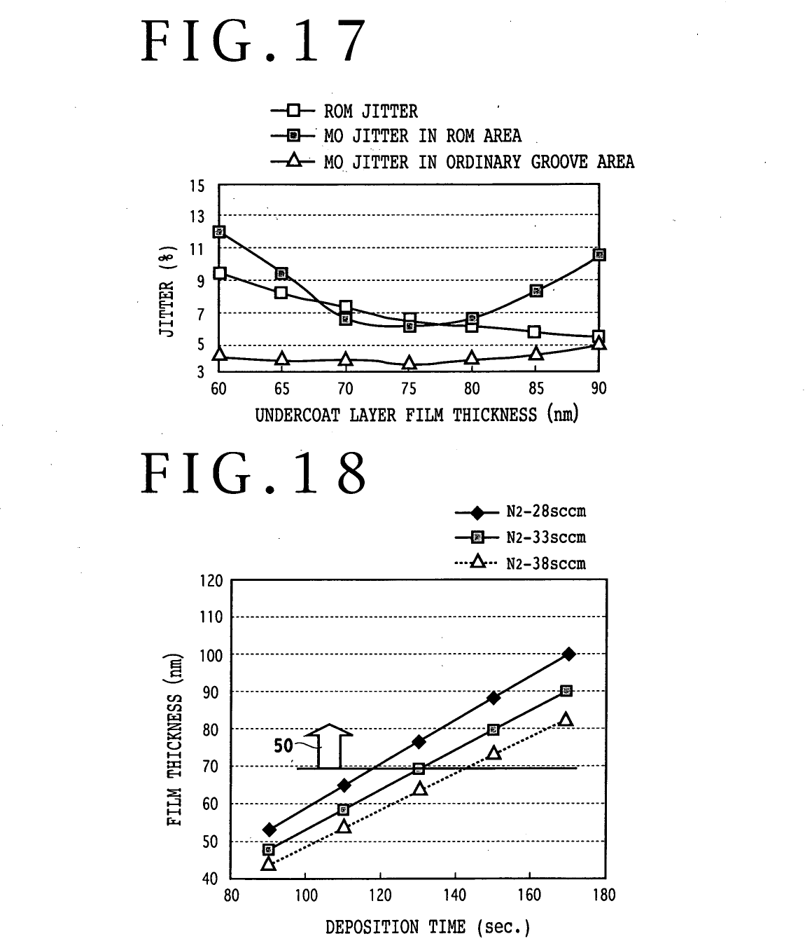

A process of improving jitter depending on the conditions of undercoat SiN layer 38 will be described below. In the process, a substrate where the angle of inclination of the phase pit edge is 18° was used. FIG. 16 shows how the reflectance changes depending on the film thickness of an undercoat SiN layer at the time the N₂ gas flows at a rate of 33 sccm. The film thickness of the undercoat SiN layer was changed by changing the deposition time. FIG. 17 shows MO signal jitter in the ROM area and ROM signal jitter at different film thicknesses of the undercoat SiN layer 38. The ROM signal jitter decreases consistently as the film thickness of the undercoat SiN layer 38 is increased to increase the reflectance. Specifically, when the reflectance is increased, the ROM signal has an increased amplitude, improving the ROM signal jitter.

The MO signal jitter in the ROM area tends to increase if the film thickness of the undercoat SiN layer 38 is 11.5% of the wavelength of the reproducing laser beam or greater, i.e., if the film thickness of the undercoat SiN layer 38 is 75 nm or greater, resulting in an increase in the reflectance. If the film thickness of the undercoat SiN layer 38 is 85 nm or greater, the MO signal jitter in the ROM area is very large. The MO signal jitter is increased because the amplitude of the ROM signal, which is responsible for noise in the reproduction of the MO signal, is increased. Based on the above results, the reflectance of the undercoat SiN layer 38 needs to be 25% or less in order to obtain favorable MO signal jitter in the ROM area.

If the film thickness of the undercoat SiN layer 38 is 70 nm or less, the MO signal jitter is large regardless of a reduction in the reflectance. Both the ROM signal jitter and the MO signal jitter in the ROM area are higher if the film thickness of the undercoat SiN layer 38 is in a low range less than 70 nm. Therefore, the film thickness of the undercoat SiN layer 38 should preferably be 70 nm or higher. For reproducing an MO signal from ordinary grooves free of phase pits, the jitter slightly increases if the film thickness of the undercoat SiN layer 38 is 85 nm or greater, but is of a sufficiently small value if the film thickness of the undercoat SiN layer 38 is in the range from 60 nm to 90 nm. Therefore, it follows that the conditions of the undercoat SiN layer need to be limited for reproducing an MO signal over phase pits.

Specifically, if a practically required level of jitter of 10% or less is to be achieved with respect to both the reproduced ROM signal and the reproduced MO signal in the ROM area, then the film thickness of the undercoat SiN layer 38 may be 10% of the wavelength of the reproducing laser beam or higher, or preferably 11% or higher, and the reflectance of the mirror surface free of phase pits with respect to the reproducing laser beam may be in the range from 18% to 25%. If the reflectance is 18% or higher, favorable ROM signal jitter is obtained. If the film thickness of the undercoat SiN layer 38 may be 10% of the wavelength of the reproducing laser beam or higher, or preferably 11% or higher, then a favorable reproduced MO signal is obtained over phase pits. In the present embodiment, the depth of phase pits is set to 40 nm because a laser beam having a wavelength of 650 nm is used. If a blue-violet laser beam having a wavelength of 405 nm is used, for example, then the depth of phase pits may be set to about 25 nm and the film thickness of the undercoat SiN layer 38 may be set to 40 nm or more to achieve the same advantages as described above.

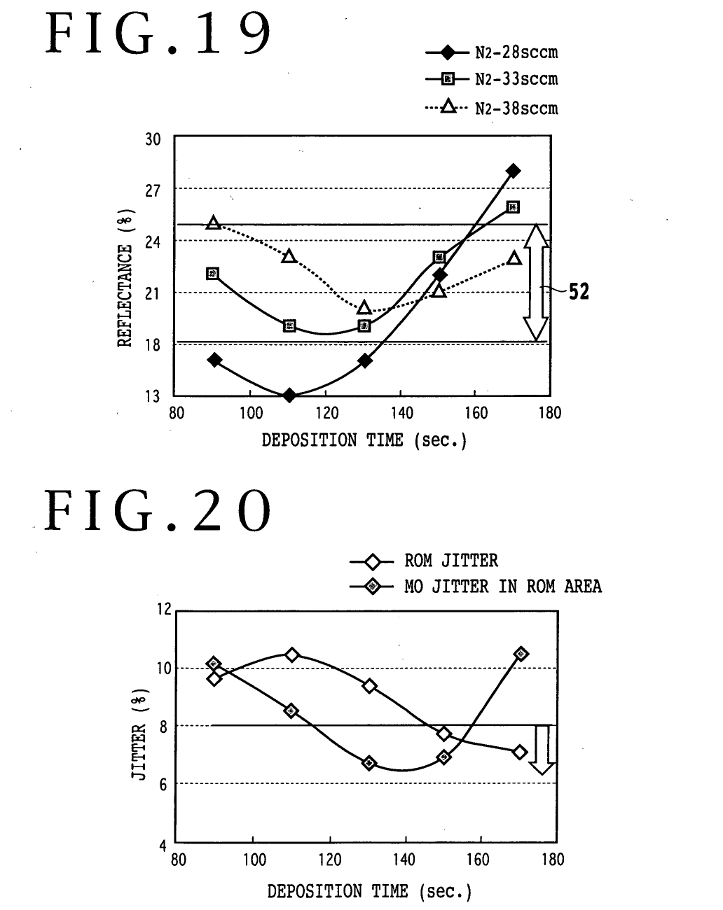

FIG. 18 shows how the film thickness of the undercoat SiN layer changes with deposition time, and FIG. 19 shows how the reflectance changes with deposition time at different N₂ gas flow rates as a parameter. As described above, in order to adjust the film thickness of the undercoat SiN layer to 70 nm or greater and the reflectance thereof to 25% or less, depositing conditions in a range indicated by the arrow 50 in FIG. 18 and the arrow 52 in FIG. 19 may be selected. For example, FIG. 20 shows ROM signal jitter and MO signal jitter in the ROM area at different deposition times when the N₂ gas flows at a rate of 28 sccm. In order to make the film thickness of the undercoat SiN layer equal to or greater than 70 nm, the deposition time needs to be 120 seconds or longer, as shown in FIG. 18. In order to make the reflectance of the undercoat SiN layer equal to or smaller than 25%, the deposition time needs to be 160 seconds or shorter, as shown in FIG. 19.

FIG. 20 shows ROM signal jitter and MO signal jitter in the ROM area at different deposition times for the undercoat SiN layer. It can be seen from FIG. 20 that the MO signal jitter in the ROM area is of a favorable value of 8% or less if the deposition time is in the range from 120 seconds to 160 seconds, and the ROM signal jitter is of a favorable value of 8% or less if the deposition time is 140 seconds or longer. A comparison of FIG. 20 with FIG. 19 indicates that the reflectance needs to be of 18% or higher for achieving favorable ROM signal jitter.

In the above embodiment, SiN is used as the dielectric material of the undercoat layer. However, other materials including AlN, SiN (SiAlN, AiAlON), SiO₂, etc. may be used to achieve the same advantages as described above.

The magneto-optical recording medium according to the present invention is effective to reduce the leakage of the phase pit signal into the MO signal and the leakage of the MO signal into the phase pit signal to improve jitter of the phase pit signal and the MO signal, thereby providing a reproduced signal with reduced noise.

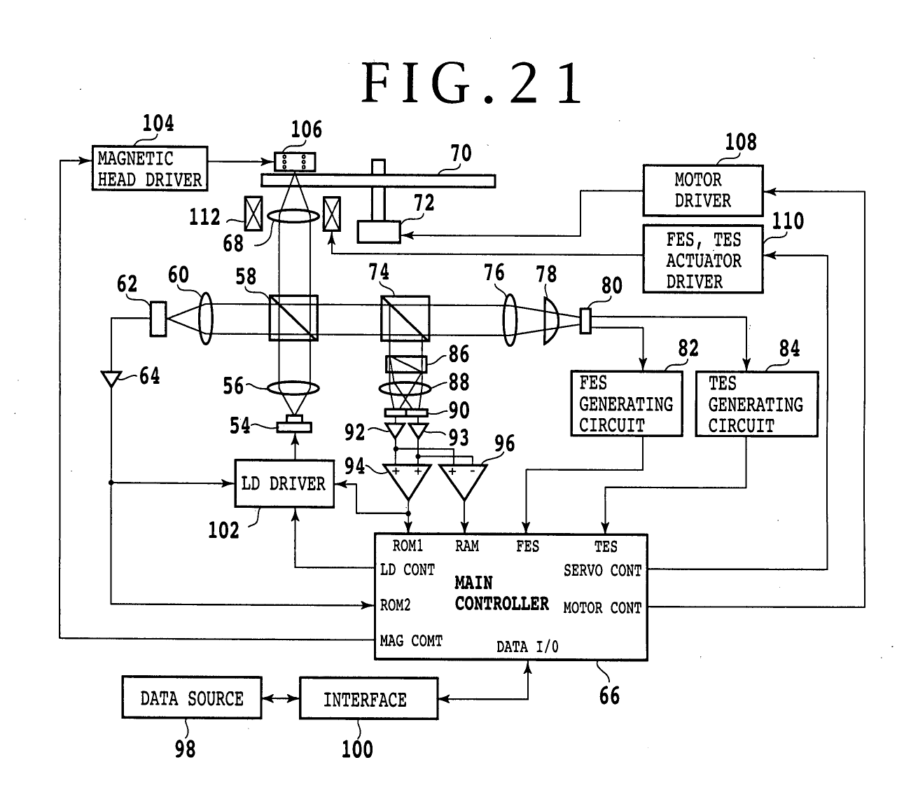

A magneto-optical disk device suitable for recording and reproducing information on and from the magneto-optical recording medium according to the present invention will be described below with reference to FIGS. 21 through 24. FIG. 21 is a block diagram of a magneto-optical disk device according to an embodiment of the present invention. As shown in FIG. 21, a laser beam emitted from a semiconductor laser diode (LD) 54 is converted by a collimator lens 56 into a collimated beam, which is applied to a polarizer beam splitter 58. A laser beam reflected from the polarizer beam splitter 58 is focused onto an automatic power control (APC) photodetector 62 by a condensing lens 60. The APC photodetector 62 converts the applied beam into an electric signal, which is applied through an amplifier 64 to a main controller 66. The main controller 66 performs an APC control or reproduces a ROM signal based on the supplied electric signal.

The plane of polarization of the laser beam is set to a direction perpendicular to the longitudinal direction (along tracks) of phase pits or a range of that direction ±5°, as described above. The diameter of the laser beam is set to a range from about twice to 10/3 of the width of each phase pit in a magneto-optical recording medium 70.

A laser beam that has passed through the polarizer beam splitter 58 is constricted substantially to a diffraction limit by an objective lens 68 and applied to the magneto-optical recording medium 70, which is being rotated by a motor 72. A laser beam that is reflected by the magneto-optical recording medium 70 is applied through the objective lens 68 to the polarizer beam splitter 58, which guides the laser beam to a servocontrol optical system and a recorded information detecting system. Specifically, the reflected laser beam from the magneto-optical recording medium 70 is reflected by the polarizer beam splitter 58 to a second polarizer beam splitter 74, which passes part of the laser beam to the servocontrol optical system and reflects part of the laser beam to the recorded information detecting system.

The laser beam that has passed through the second polarizer beam splitter 74 travels through a condensing lens 76 and a cylindrical lens 78 of the servocontrol optical system and is applied to a four-segment photodetector 80, which converts the laser beam into an electric signal. The electric signal output from the four-segment photodetector 80 is supplied to an astigmatic FES (Focus Error Signal) generating circuit 82, which generates a focus error signal based on the supplied electric signal. The electric signal output from the four-segment photodetector 80 is also supplied to a push-pull TES (Tracking Error Signal) generating circuit 84, which generates a tracking error signal based on the supplied electric signal. The focus error signal generated by the FES generating circuit 82 and the tracking error signal generated by the TES generating circuit 84 are supplied to the main controller 66.

In the recorded information detecting system, the laser beam that has been reflected by the second polarizer beam splitter 74 is applied to a Wollastone prism 86, which converts the polarized characteristics of the reflected laser beam that vary depending on the direction of magnetization of magneto-optically recorded spots on the magneto-optical recording medium 70, into light intensity. Specifically, the Wollastone prism 86 divides the polarized beam into two beams whose directions of polarization are perpendicular to each other. The two beams are then applied through a condensing lens 88 to a two-segment photodetector 90, which converts the beams into respective electric signals.

The electric signals output from the two-segment photodetector 90 are amplified by respective amplifiers 92 and 93. The amplified signals from the amplifiers 92, 93 are added to each other by a summing amplifier 94, which produces a first ROM signal (ROM1). The amplified signals from the amplifiers 92 and 93 are subtracted one from the other by a subtracting amplifier (differential amplifier) 96, which produces a RAM signal (RAM). The first ROM signal (ROM1) and the RAM signal (RAM) are supplied to the main controller 66. The first ROM signal (ROM1) is also used as a feedback signal for suppressing the light intensity modulation due to the phase pit signal.

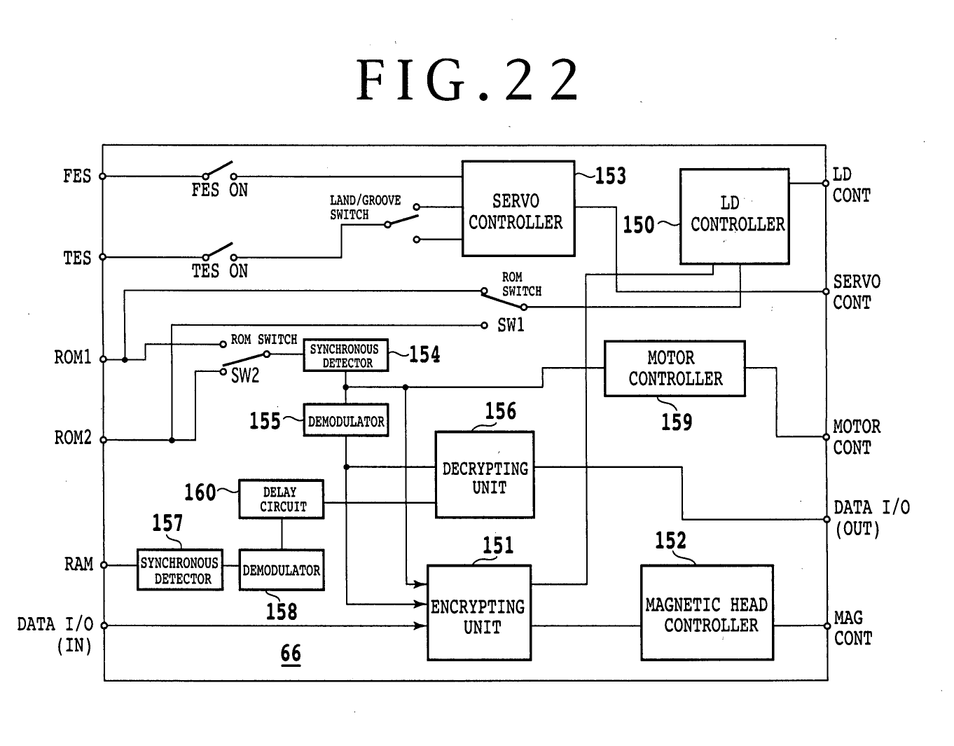

The flow of laser beams at the time of reading a signal has been described above. Now, a flow of output signals from the photodetectors 62, 80, and 90 will be described below with reference to FIG. 22, which shows details of the main controller 66. As shown in FIG. 22, the reflected laser beam from the polarizer beam splitter 58 is applied to the APC photodetector 62 and converted thereby into an electric signal, which is applied as a second ROM signal (ROM2) through the amplifier 64 to the main controller 66. The main controller 66 is also supplied with the first ROM signal (ROM1) from the summing amplifier 94, the RAM signal (RAM) from the differential amplifier 96, the focus error signal (FES) from the FES generating circuit 82, and the tracking error signal (TES) from the TES generating circuit 84.

As shown in FIG. 21, recording data and readout data are exchanged between a data source 98 and the main controller 66 through an interface circuit 100. The first ROM signal (ROM1), the second ROM signal (ROM2), and the RAM signal (RAM) that are supplied to the main controller 66 are detected and used in various modes, i.e., a ROM and RAM playback mode, a ROM-only playback mode, and a recording (WRITE) mode.

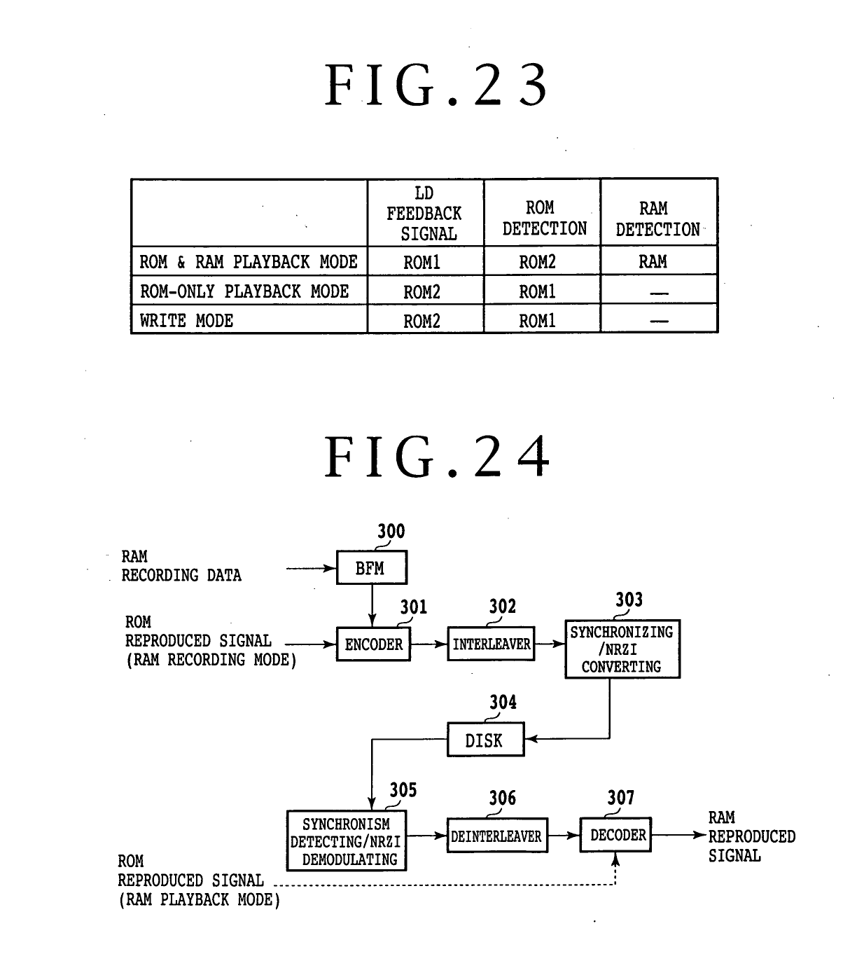

FIG. 23 shows detected combinations of ROM1, ROM2, and RAM in the various modes. For making such detected combinations of ROM1, ROM2, and RAM in the various modes, the main controller 66 shown in FIG. 22 has ROM selector switches SW1 and SW2. The states of the ROM selector switches SW1 and SW2, which are illustrated in FIG. 22, correspond to the ROM and RAM playback mode of the modes shown in FIG. 23. In the ROM-only playback mode and the recording mode, the ROM selector switches SW1 and SW2 shown in FIG. 22 are reversed.

The main controller 66 has an LD controller 150 for generating a command signal to be supplied to an LD driver 102 (see FIG. 21) in response to output signals from an encrypting unit 151 and the ROM selector switch SW1. Based on the command signal from the LD controller 150, the LD driver 102 controls the light emission power of the LD 54 based on the first ROM signal (ROM1) through a negative feedback control loop in the ROM and RAM playback mode, and also controls the light emission power of the LD 54 based on the second ROM signal (ROM2) through a negative feedback control loop in the ROM-only playback mode and the recording mode.

For recording a magneto-optical signal, data from the data source 98 is supplied through the interface 100 to the main controller 66. In the main controller 66, the supplied data is encrypted by the encrypting unit 151 for security purposes, and then supplied as encrypted recording data through a magnetic head controller 152 to a magnetic head driver 104 (see FIG. 21). Based on the encrypted recording data, the magnetic head driver 104 energizes a magnetic head 106 to modulate a magnetic field depending on the encrypted recording data. At this time, the encrypting unit 151 sends a signal indicative of the recording mode to the LD driver 102, which controls the light emission power of the LD 54 to achieve a laser power level suitable for the recording of the data based on the second ROM signal (ROM2) through a negative feedback control loop.

FIG. 24 shows details of the encrypting unit 151 and a decrypting unit 156, and a processing sequence thereof. In the encrypting unit 151, a digital RAM signal representative of RAM recording data to be magneto-optically recorded is supplied through a buffer memory 300 to an encoder 301. The encoder 301 is also supplied with a ROM signal reproduced by a demodulator 155. The encoder 301 encodes the RAM signal using the ROM signal. The encoder 301 applies an encoded output signal to an interleaving circuit 302, which interleaves a serial bit train of the encoded output signal according to predetermined rules for randomizing positive and negative signs. An output signal from the interleaving circuit 302 is synchronized with a clock signal regenerated from the ROM signal and converted into an NRZI signal as RAM recording information by a synchronizing and converting circuit 303. The RAM recording information is then magneto-optically recorded in the ROM area over fixedly recorded phase pits in a land area of the magneto-optical recording medium 70.

When a RAM signal is read from the magneto-optical recording medium 70, it is supplied to the decrypting unit 156. In the decrypting unit 156, the RAM signal is processed successively by a synchronism detecting and demodulating circuit 305, a deinterleaving circuit 306, and a decoder 307, which performs respective processes that are a reversal of the processes performed by the synchronizing/converting circuit 303, the interleaving circuit 302, and the encoder 301 in the encrypting unit 151, thereby producing a decrypted RAM signal. With the above arrangement, the ROM signal and the RAM signal can be combined with each other for error correction. Specifically, in FIG. 24, as indicated by the broken-line arrow, when a RAM signal is reproduced by the decrypting unit 156, the RAM signal is error-corrected using part of the reproduced ROM signal. For example, the encoder 301 combines one bit extracted from the ROM signal with the RAM signal, and outputs the combined signals as RAM information, which is recorded on the magneto-optical recording medium 70. When the RAM signal is reproduced, the decoder 307 performs a parity check on the RAM signal. In this manner, error correction can be performed based on a combination of the ROM signal and the RAM signal.

As shown in FIG. 22, based on a clock signal regenerated from the first ROM signal (ROM1), a motor controller 159 controls the rotation of the motor 72 through a motor driver 108 (see FIG. 21) in part of a seek process. A servocontrol signal output from a servocontroller 153 is applied to an actuator driver 110 shown in FIG. 21 to energize an actuator 112 based on the FES and/or the TES.

Operation of the magneto-optical disk device in a playback mode will be described below. As described above, the light intensity modulation due to a phase pit signal, i.e., a ROM signal that is read, serves as noise with respect to a RAM signal. Therefore, the first ROM signal (ROM1) from the summing amplifier 94 can be applied through a negative feedback loop to the LD 54 via the LD driver 102 for controlling the light emission of the LD 54 to reduce and flatten the first ROM signal (ROM1). In this manner, it is possible to efficiently suppress crosstalk between the first ROM signal (ROM1) and the RAM signal that is read.

When the first ROM signal (ROM1) and the RAM signal are simultaneously read from the magneto-optical recording medium 70, however, since the first ROM signal is flattened by the above negative feedback control process, it is difficult to obtain a ROM signal. Therefore, a ROM signal has to be detected by another process. According to the present embodiment, the current supplied to the LD 54 is modulated in a negative feedback control loop by the first ROM signal (ROM1) in the playback mode, i.e., the current supplied to the LD 54 is modulated by the intensity of light in the same pattern as the ROM signal. The light intensity modulation can be detected by the APC photodetector 62. When an MPF loop is in operation, an APC loop is turned off to obtain the phase pit signal as the second ROM signal (ROM2).

According to the present invention, a clock signal is reproduced from the second ROM signal (ROM2) by a synchronous detecting circuit 154 in the main controller 66 shown in FIG. 22, and the second ROM signal (ROM2) is demodulated from EFM information into ROM information by the demodulator 155. The demodulated ROM information is decrypted by the decrypting unit 156 from encrypted data generated by the encrypting unit 151 into reproduced data, which is output from the main controller 66.

When ROM information and RAM information are simultaneously reproduced, the motor controller 159 controls the rotation of the motor 72 through the motor driver 108 in part of a seek process based on the clock signal regenerated from the second ROM signal (ROM2) by the synchronous detecting circuit 154. The RAM signal can be detected as an output signal from the differential amplifier 96 without interference with the ROM signal by a ROM signal negative feedback means including the LD driver 102 connected to the LD 54.

The output signal from the differential amplifier 96 is synchronously detected by a synchronous detecting circuit 157, demodulated from an NRZI demodulated signal by a demodulator 158, and decrypted into a RAM signal by decrypting unit 156 in the main controller 66. As shown in FIG. 22, the main controller 66 has a delay circuit 160 for making a timing adjustment to correct a timing shift. The timing shift has been introduced in recording RAM information over ROM information in order to reduce polarization noise that is produced by a phase pit edge representing the ROM information when the RAM signal is reproduced. In the ROM-only playback mode, since effects on the RAM signal do not need to be taken into account, a second RAM signal (RAM2) is used as an LD feedback signal as in the recording mode, and the first ROM signal (ROM1) is demodulated into ROM information.

The magneto-optical storage device according to the present invention can use not only a concurrent ROM-RAM medium, but also a MO medium or a CD medium.

The magneto-optical recording medium, thus arranged, according to the present invention is capable of stably reproducing both ROM information and RAM information and improving ROM signal jitter and RAM signal jitter from a ROM area when ROM information and RAM information are simultaneously read from the magneto-optical recording medium. Since the magneto-optical recording medium according to the present invention is capable of simultaneously reproducing both ROM information and RAM information of good quality, the present invention can provide a simultaneously ROM and RAM recording and reproducing medium depending on applications.

1. A magneto-optical recording medium comprising:
a substrate having a ROM area with a plurality of phase pits defined therein as providing a ROM signal; and
a magneto-optical recording film deposited in an area of said substrate which corresponds to said ROM area, for recording a RAM signal;
said phase pits having edges having an average angle of inclination ranging from 10° to 40° at a position in a range of one-half of the depth of each of the phase pits ±20%.

2. The magneto-optical recording medium according to claim 1, wherein said average angle of inclination ranges from 15° to 30°.

3. The magneto-optical recording medium according to claim 1, wherein each of said phase pits has a width ranging from 300 nm to 500 nm.

4. The magneto-optical recording medium according to claim 1, wherein each of said phase pits is modulated by a modulation factor ranging from 10% to 30%.

5. The magneto-optical recording medium according to claim 1, further comprising a dielectric layer disposed between said substrate and said magneto-optical recording film, said dielectric layer having a film thickness which is at least 10% of the wavelength of a reproducing laser beam to be applied to the magneto-optical recording medium, said magneto-optical recording medium having a reflectance ranging from 18% to 25% with respect to said reproducing laser beam in a region free of said phase pits.

6. The magneto-optical recording medium according to claim 1, wherein each of said phase pits has a width ranging from 30% to 50% of the diameter of a reproducing laser beam.

7. A magneto-optical storage device for at least reading information recorded in a magneto-optical recording medium, comprising:
an optical head for applying a linearly polarized laser beam to the magneto-optical recording medium; and
a photodetector for generating a reproduced signal from a light beam reflected from the magneto-optical recording medium;
said magneto-optical recording medium comprising:
a substrate having a ROM area with a plurality of phase pits defined therein as providing a ROM signal; and
a magneto-optical recording film deposited in an area of said substrate which corresponds to said ROM area, for recording a RAM signal;
said phase pits having edges having an average angle of inclination ranging from 10° to 40° at a position in a range of one-half of the depth of each of the phase pits ±20%.

8. The magneto-optical storage device according to claim 7, wherein the laser beam applied to the magneto-optical recording medium has a plane of polarization set to a range of a direction perpendicular to the longitudinal direction of the phase pits ±5°.

9. The magneto-optical storage device according to claim 7, wherein said laser beam has a diameter established such that each of said phase pits has a width ranging from 30% to 50% of the diameter of said laser beam.

10. The magneto-optical storage device according to claim 7, wherein said magneto-optical recording medium further comprises a dielectric layer disposed between said substrate and said magneto-optical recording film, said dielectric layer having a film thickness which is at least 10% of the wavelength of said laser beam applied to the magneto-optical recording medium, said magneto-optical recording medium having a reflectance ranging from 18% to 25% with respect to the reflected light beam in a region free of said phase pits.

11. A stamper for producing a substrate having a plurality of phase pits, comprising:
a plurality of lands complementary in shape to the phase pits, respectively;
said lands having edges having an average angle of inclination ranging from 10° to 40° at a position in a range of one-half of the height of each of the lands ±20%.

12. The stamper according to claim 11, wherein said average angle of inclination ranges from 15° to 30°.

13. A magneto-optical storage device for at least reading information recorded in a magneto-optical recording medium, comprising:
an optical head for applying a linearly polarized laser beam to the magneto-optical recording medium; and
a photodetector for generating a reproduced signal from a light beam reflected from the magneto-optical recording medium;
said magneto-optical recording medium comprising:
a substrate having a ROM area with a plurality of phase pits defined therein as providing a ROM signal;
wherein the laser beam applied to the magneto-optical recording medium has a plane of polarization set to a range of a direction perpendicular to the longitudinal direction of the phase pits ±5°.

14. The magneto-optical storage device according to claim 13, wherein said magneto-optical recording medium has a magneto-optical recording film deposited in an area of said substrate which corresponds to said ROM area, for recording a RAM signal, and each of said phase pits is modulated by a modulation factor ranging from 10% to 30%.

15. The magneto-optical storage device according to claim 13, wherein said magneto-optical recording medium has a magneto-optical recording film deposited in an area of said substrate which corresponds to said ROM area, for recording a RAM signal, and said laser beam has a diameter established such that each of said phase pits has a width ranging from 30% to 50% of the diameter of said laser beam.
